(19) United States
(12) Patent Application Publication
(10) Pub. No.: US 2007/0037694 A1
(43) Pub. Date: Feb. 15, 2007

(54) Composite fiber

(75) Inventors: Yen-Jung Hu, Hsin-Chu City (TW); Hsi-Yu Chen, Tainan City (TW); Chih-Hsiang Lin, Ping-Tung Hsien (TW)

Correspondence Address: HAMRE, SCHUMANN, MUELLER & LARSON, P.C., P.O. BOX 2902, MINNEAPOLIS, MN, 55402-0902, US

(73) Assignee: KANG NA HSIUNG ENTERPRISE CO., LTD., Tainan Hsien (TW)

(21) Appl. No.: 11/328,339

(22) Filed: Jan. 9, 2006

(30) Foreign Application Priority Data
Aug. 12, 2005 (TW) 094127534
Aug. 12, 2005 (TW) 094127535

(51) Int. Cl. B01J 31/00

(52) U.S. Cl. 502/159

(57) ABSTRACT

A composite fiber includes: a first fiber component made from a first organic polymer, and a second fiber component made from a second organic polymer and particulate photocatalyst, such as titanium oxide. The first and second organic polymers are independently selected from polyester, polycarbonate, polyamide, polyolefin, polyacrylate, polyvinyl alcohol, polyethylene chloride, polyethylene fluoride, polystyrene, and combinations thereof.

### CROSS-REFERENCE TO RELATED APPLICATIONS

This application claims priority of Taiwanese applications no. 094127534 and 094127535, both filed on Aug. 12, 2005.

### BACKGROUND OF THE INVENTION

1. Field of the Invention

This invention relates to a composite fiber, more particularly to a composite fiber with particulate photocatalyst.

2. Description of the Related Art

In recent years, much attention has been paid to antibiotic, antifouling, air-cleaning, and deodorizing functions of photocatalysts. The aforesaid functions are realized by electrons and holes generated by exposing photocatalysts to ultraviolet light or sunlight. The electrons and holes thus formed react with oxygen and water nearby so as to generate superoxide anion and hydroxyl radical. Upon reacting with organic matter, hydroxyl radical will cause an oxidation in the organic matter, thereby resulting in decomposition of the organic matter.

With their ability to decompose organic matter, photocatalysts have been widely used in several fields, for example, fluid-cleaning systems. In the conventional fluid-cleaning system, photocatalyst typically is coated on a wall of the fluid-cleaning system or on a filter in the form of a thin layer. For example, U.S. Pat. No. 5,790,934 and U.S. Pat. No. 6,063,343 disclose a reactor comprising a plurality of fins coated with a photocatalyst. Also, TW 402162 discloses a UV/titanium oxide photo-oxidation device comprising a stirring unit with a plurality of stirring fins coated with a photocatalyst. In addition, photocatalysts can be coated on a surface of a support structure, such as glass beads, ceramics, and stainless steel beads, based on the actual requirements. However, as reaction time increases, some problems are encountered, e.g., peeling of the coated photocatalyst from the support structure, and decline in the photocatalyst efficiency due to insufficient absorbance of ultraviolet light. In addition, peeling of the coated photocatalyst is much more serious in the water-cleaning system. Although attempts have been tried to coat photocatalyst on a flexible support, such as fiber or fabric, the peeling problem still exists. Therefore, there is a need for preventing coated photocatalyst from peeling from a support structure.

On the other hand, in order to achieve optimal photocatalystic effect, attempts have been tried to directly add photocatalyst particles into wastewater in a water-cleaning device for decomposing organic matters in wastewater. For example, U.S. Pat. No. 5,174,877 and U.S. Pat. No. 5,294,315 disclose systems for treating a contaminated fluid. The systems include a reactor tank for receiving the contaminated fluid and photocatalystic particles. Since the particle diameter of commercially available photocatalysts ranges from several ten to several hundred nanometers, after photocatalyzing wastewater, it is necessary to separate photocatalyst from processed water by using a filter. However, photocatalyst particles can plug the pores of the filter during filtration. As a consequence, the reaction is required to be stopped for replacing a new filter. As such, the manufacturing cost is considerably increased, and the cleaning efficiency is reduced. Therefore, there is a need in the art to prevent blocking of the filter by the photocatalyst particles.

### SUMMARY OF THE INVENTION

Therefore, the object of the present invention is to provide a composite fiber that can overcome the aforesaid drawbacks of the prior art.

According to this invention, a composite fiber comprises a first fiber component made from a first organic polymer, and a second fiber component made from a second organic polymer and particulate photocatalyst.

### BRIEF DESCRIPTION OF THE DRAWINGS

Other features and advantages of the present invention will become apparent in the following detailed description of the preferred embodiments of this invention, with reference to the accompanying drawings, in which:

FIG. 1 is across-sectional view of the first preferred embodiment of a composite fiber according to this invention;

FIG. 2 is a cross-sectional view of the second preferred embodiment of a composite fiber according to this invention;

FIG. 3 is a perspective view showing a fiber bundle formed from the composite fibers according to this invention;

FIG. 4 is a perspective view showing a texturized fiber formed from the composite fibers according to this invention;

FIG. 5 is a perspective view showing a fabric formed from the composite fibers according to this invention;

FIG. 6 is a perspective view showing a non-woven fabric formed from the composite fibers according to this invention;

FIG. 7 is a perspective view showing a braided fabric formed from the composite fibers according to this invention;

FIG. 8 is a schematic view of the first preferred embodiment of a fluid-cleaning device using the composite fibers of this invention;

FIG. 9 is a schematic view of the second preferred embodiment of a fluid-cleaning device using the fiber bundle formed from the composite fibers of this invention; and

FIG. 10 is a cross-sectional view of a photocatalyst-containing fiber unit taken along line X-X in FIG. 9.

### DETAILED DESCRIPTION OF THE PREFERRED EMBODIMENTS

The composite fiber according to this invention comprises a first fiber component made from a first organic polymer, and a second fiber component made from a second organic polymer and particulate photocatalyst. The particulate photocatalyst is dispersed in the second organic polymer.

The first organic polymer and the second organic polymer are independently selected from the group consisting of polyester, polycarbonate, polyamide, polyolefin, polyacrylate, polyvinyl alcohol, polyethylene chloride, polyethylene fluoride, polystyrene, and combinations thereof. If optical polymer with good light transmittance, e.g., fluoropolymer, polymethyl methacrylate, polycarbonate and polystyrene, is used as the first organic polymer and the second organic polymer, the photocatalystic activity can be enhanced. Preferably, the first organic polymer and the second organic polymer are polyethylene terephthalate or polymethylmethacrylate (PMMA).

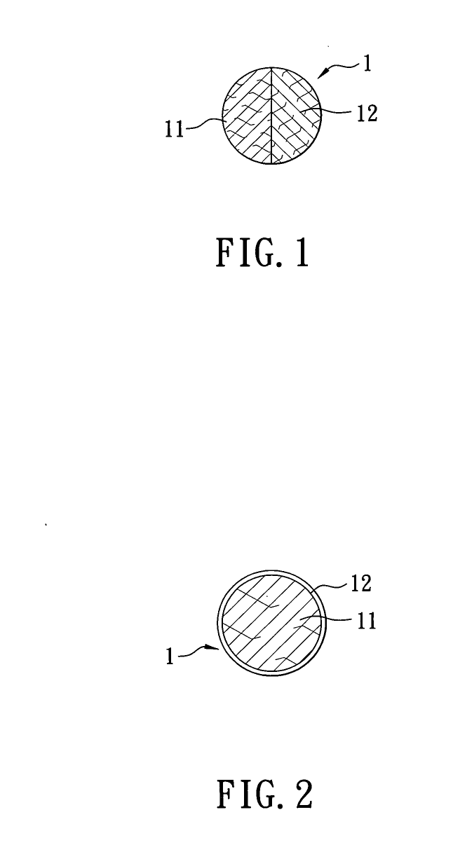

FIG. 1 illustrates the first preferred embodiment of the composite fiber 1 according to this invention. In this embodiment, the first fiber component 11 and the second fiber component 12 are co-extruded in a side-by-side arrangement. The first fiber component 11 is present in an amount ranging from 20 to 80 vol %, and the second fiber component 12 is present in an amount ranging from 20 to 80 vol %. Preferably, each of the first fiber component 11 and the second fiber component 12 is present in an amount of 50 vol %.

FIG. 2 illustrates the second preferred embodiment of the composite fiber 1 according to this invention. In this embodiment, the first fiber component 11 and the second fiber component 12 are co-extruded in a core-and-sheath arrangement. The first fiber component 11 defines the core portion, and the second fiber component 12 defines the sheath portion. The first fiber component 11 is present in an amount ranging from 40 to 90 vol %, and the second fiber component 12 is present in an amount ranging from 10 to 60 vol %. Preferably, the first fiber component 11 is present in an amount ranging from 70 to 90 vol %, and the second fiber component 12 is present in an amount ranging from 10 to 30 vol %. The ranges mentioned above are exemplary, and should not be construed as limiting the scope of this invention. Specifically, the content of the second fiber component 12 is in an amount sufficient to fully cover the surface area of the first fiber component 11.

Furthermore, the photocatalyst used is a commercially available product, such as TiO₂, ZnO, SnO, WO, Fe₂O₃, etc. The diameter of the particulate photocatalyst can be varied based on the actual requirements. It is preferable that the photocatalyst dispersed in the second organic polymer is titanium dioxide in the form of anatase crystal. The diameter of the photocatalyst ranges from 10 nm to 900 nm, preferably from 10 nm to 500 nm, and more preferably from 10 nm to 200 nm, and most preferably from 10 nm to 100 nm.

The cross-sectional diameter, length, and shape of the composite fiber according to this invention can be varied based on the actual requirements. The cross-sectional diameter of the composite fiber ranges from 5 μm to 2 mm , and preferably from 10 to 100 μm. The length of the composite fiber ranges from 1 mm to 80 mm.

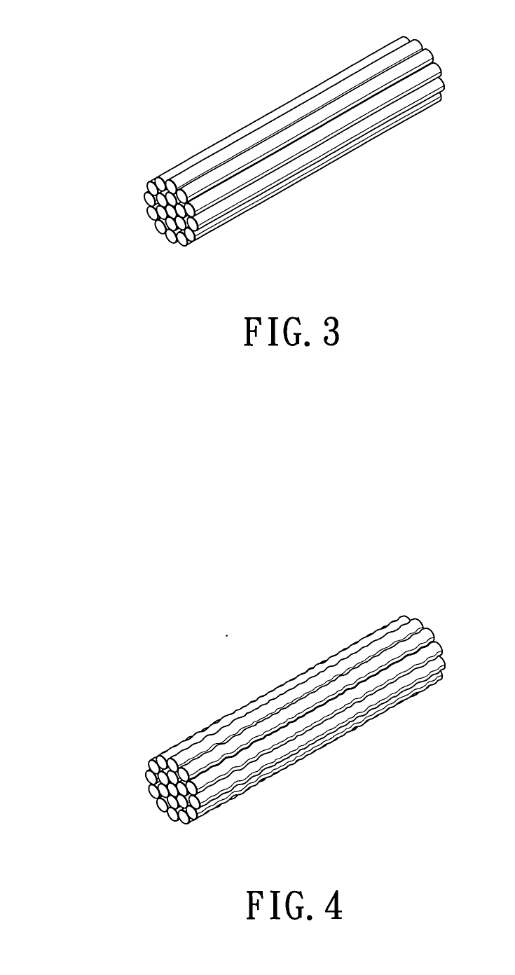

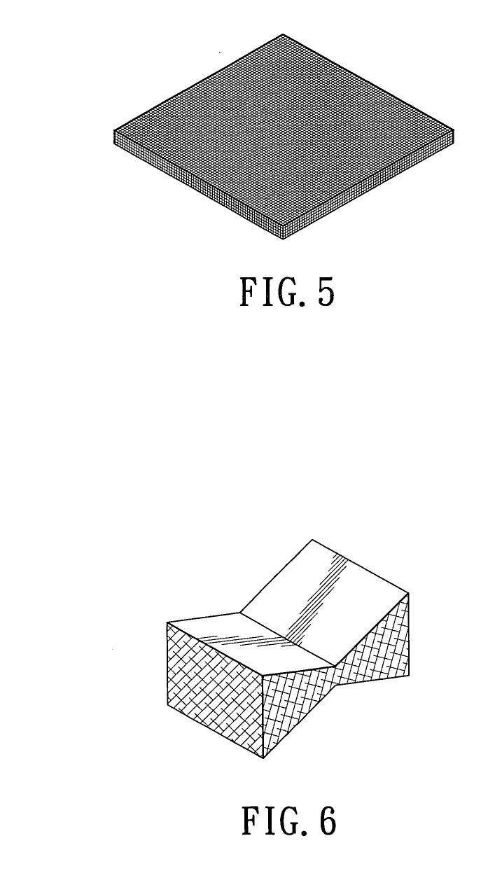

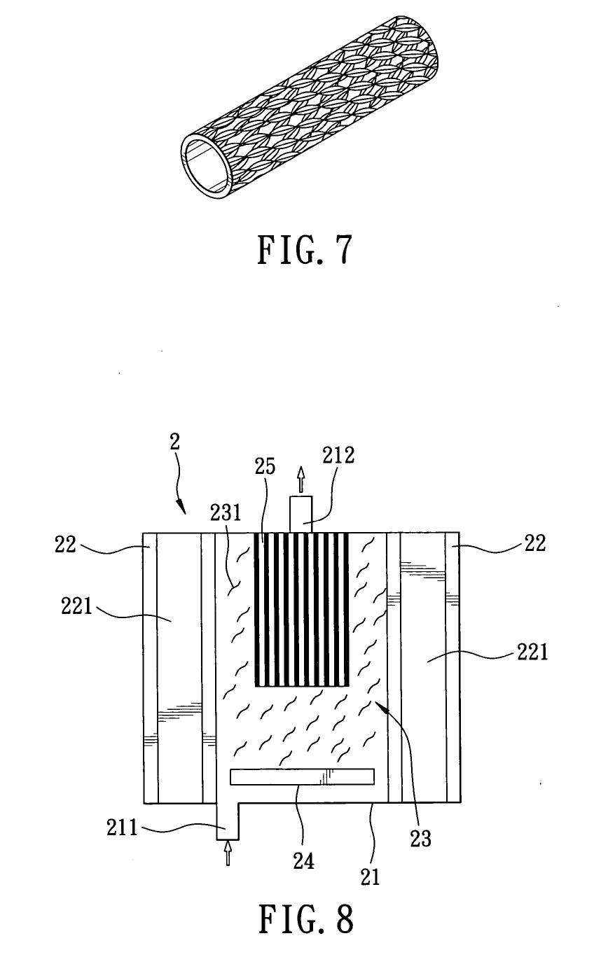

As shown in FIGS. 3 to 7, the composite fiber can be further processed into fiber assemblies, such as fiber bundle, bulky fibers, fabric, non-woven fabric, and braided fabric.

Fiber bundle is formed by assembling, fixing, and cutting the composite fibers. Bulky fibers are produced by crimping, assembling, fixing, and cutting the composite fibers. Non-woven fabric is manufactured through opening, carding, lapping and consolidation processes. The non-woven fabric thus formed can be further structurally reinforced, e.g., bonded, and then cut into desired dimension so as to obtain a stronger non-woven fabric, such as the one shown in FIG. 6. Braided fabric is producing by braiding and cutting processes.

FIG. 8 illustrates the first preferred embodiment of fluid-cleaning device, i.e., a water-cleaning device 2 according to this invention. The water-cleaning device 2 includes: a reactor unit 21 for receiving wastewater to be processed; a photocatalyst unit 23 disposed in the reactor unit 21 to contact wastewater to be processed and including the composite fibers 231 of this invention; and light units 22 for irradiating the photocatalyst unit 23 to activate the particulate photocatalyst.

The reactor unit 21 includes an inlet 211 and an outlet 212. The light units 22 are provided with UV lamps 221 and are respectively disposed at two opposite sides of the reactor unit 21. The composite fibers 231 of the photocatalyst unit 23 are freely suspended in the reactor unit 21.

The water-cleaning device 2 further comprises a stirring unit 24 near the inlet 211 for stirring wastewater in the reactor unit 21, thereby enhancing contact between wastewater and the composite fibers 231. In addition, the water-cleaning device 2 further includes a filter 25 for separating the composite fibers 231 from the processed water prior to discharge of the treated water through the outlet 212.

In operation, wastewater to be cleaned is introduced into the reactor unit 21 through the inlet 211 to contact the composite fibers 231 of the photocatalyst unit 23. UV light generated by the light units 22 is guided into the reactor unit 21 to activate the photocatalyst in the composite fibers 231. After reaction, the cleaned water is separated from the composite fibers 231 by the filter 25, and is discharged from the reactor unit 21 through the outlet 212.

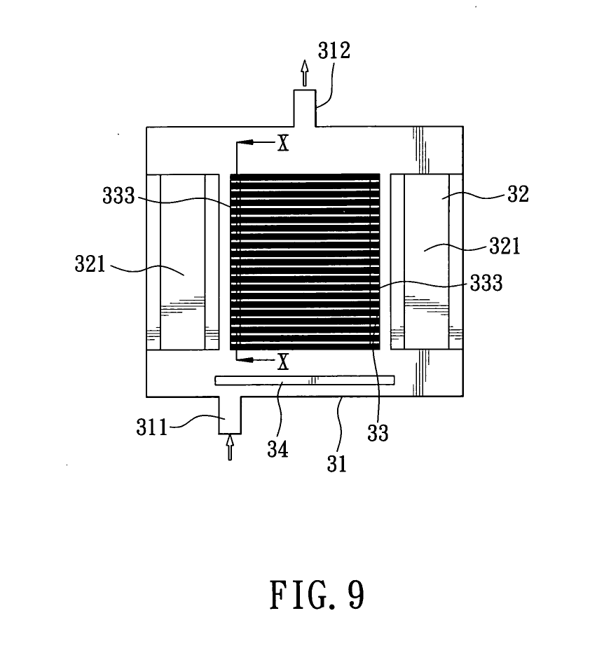

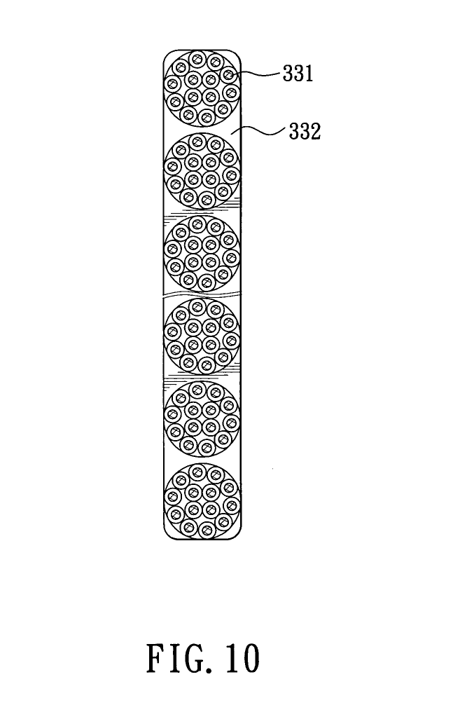

FIG. 9 illustrates the second preferred embodiment of a fluid-cleaning device, i.e., a water-cleaning device 3 according to this invention. The water-cleaning device 3 includes: a reactor unit 31 for receiving wastewater to be processed; a photocatalyst-containing fiber unit 33 disposed in the reactor unit 31 to contact wastewater to be processed and including fiber bundles 331 (see FIG. 10) obtained from Example 2 to be described hereinafter; and a light unit 32 for irradiating the photocatalyst-containing fiber unit 33 to activate the particulate photocatalyst.

The reactor unit 31 includes an inlet 311 and an outlet 312. The light unit 32 includes UV lamps 321 disposed at two opposite sides of the reactor unit 31. As shown in FIG. 10, a plurality of fiber bundles 331 are arranged in the reactor unit 21 in a parallel manner and are grouped together by applying resin at the two sides of the fiber bundles 331. The photocatalyst-containing fiber unit 33 is provided with a light guiding surface 333 at the two sides of fiber bundles 331 to guide light irradiated from the UV lamps 321 of the light unit 32 into the fiber bundles 331 of the photocatalyst-containing fiber unit 33.

The water-cleaning device 3 further includes a stirring unit 34 near the inlet 311 for stirring wastewater in the reactor unit 31.

The composite fiber with photocatalyst can be used to clean air or water. In this invention, water is used as an example for illustration.

### EXAMPLE 1

70 vol % Polyethylene terephthalate as a first component and 30 vol % of a mixture of polyethylene terephthalate and TiO₂ (99:1 wt %) as a second component were subjected to bicomponent spinning process to obtain a composite fiber with a diameter of 0.2 mm. The composite fiber thus formed was cut into 5 mm length.

The composite fiber thus obtained was then dispersed in 20 ml, 10 ppm methylene blue solution, and was irradiated with UV light to observe the color change of methylene blue solution. After 18 hours of reaction, the color of the methylene blue solution changed from blue to colorless. It is apparent that the composite fiber of this invention exhibits photocatalystic effect.

### EXAMPLE 2

80 vol % Polymethylmethacrylate as a first component and 20 vol % of a mixture of polymethylmethacrylate and TiO₂ (99:1 wt %) as a second component were subjected to bicomponent spinning process to obtain a composite fiber with a diameter of 0.2 mm. The composite fibers thus obtained were subjected to bundling and cutting processes to form a fiber bundle with a length of 10 cm.

The composite fiber thus obtained was then dispersed in 20 ml, 10 ppm methylene blue solution, and was irradiated with UV light to observe the color change of methylene blue solution. After 20 hours of reaction, the color of the methylene blue solution changed from blue to colorless. It is apparent that the composite fiber of this invention exhibits photocatalystic effect.

Since the second fiber component of the composite fiber of this invention is formed by first mixing the photocatalyst and the second organic polymer and then extruding the mixture, the aforesaid peeling problem associated with the prior art during wastewater treatment can be eliminated.

While the present invention has been described in connection with what is considered the most practical and preferred embodiments, it is understood that this invention is not limited to the disclosed embodiments but is intended to cover various arrangements included within the spirit and scope of the broadest interpretation and equivalent arrangements.

What is claimed is:

1. A composite fiber comprising:
a first fiber component made from a first organic polymer; and
a second fiber component made from a second organic polymer and particulate photocatalyst.

2. The composite fiber of claim 1, wherein said particulate photocatalyst is dispersed in said second organic polymer.

3. The composite fiber of claim 1, wherein said first fiber component and said second fiber component are co-extruded in a side-by-side arrangement.

4. The composite fiber of claim 1, wherein said first fiber component and said second fiber component are co-extruded in a core-and-sheath arrangement.

5. The composite fiber of claim 1, wherein said first organic polymer and said second organic polymer are independently selected from the group consisting of polyester, polycarbonate, polyamide, polyolefin, polyacrylate, polyvinyl alcohol, polyethylene chloride, polyethylene fluoride, polystyrene, and combinations thereof.

6. The composite fiber of claim 5, wherein said first organic polymer and said second organic polymer are polyethylene terephthalate.

7. The composite fiber of claim 5, wherein said first organic polymer and said second organic polymer are polymethylmethacrylate (PMMA).

8. The composite fiber of claim 1, wherein said photocatalyst is present in an amount ranging from 0.5 to 8 wt % of said second fiber component.

9. The composite fiber of claim 1, wherein said particulate photocatalyst is titanium dioxide.

10. The composite fiber of claim 1, wherein the diameter of said particulate photocatalyst ranges from 10 nm to 100 nm.

11. The composite fiber of claim 1, wherein said composite fiber has a diameter ranging from 5 μm to 2 mm.
